(19) United States
(12) Patent Application Publication
(10) Pub. No.: US 2026/0213100 A1
(43) Pub. Date: Jul. 23, 2026

(54) ARC EXTINGUISHING CHAMBER STRUCTURE OF A CIRCUIT BREAKER OR A DISCONNECTING SWITCH

(71) Applicant: SHANGHAI SIEYUAN LOW VOLTAGE SWITCH CO., LTD., SHANGHAI (CN)

(72) Inventors: LIN CAO, SHANGHAI (CN); HUA CUI, SHANGHAI (CN)

(73) Assignee: SHANGHAI SIEYUAN LOW VOLTAGE SWITCH CO., LTD., SHANGHAI (CN)

(21) Appl. No.: 19/567,380

(22) Filed: Mar. 16, 2026

Related U.S. Application Data
(63) Continuation of application No. PCT/CN2024/084070, filed on Mar. 27, 2024.

(51) Int. Cl. H01H 33/08

(52) U.S. Cl. CPC H01H 33/08

(57) ABSTRACT

The present invention relates to the technical field of low-voltage electrical equipment, and discloses an arc extinguishing chamber structure of a circuit breaker or a disconnecting switch. The whole adopts a plug-in structure assembly, a number of internal grid plates are arranged in an undulating manner, a variable curved surface formed by bottom surfaces thereof is designed to match an arc elongation process, and a thickness of each grid plate gradually becomes thinner from thick along an arc elongation direction. An assembly method of the arc extinguishing chamber structure of the circuit breaker or the disconnecting switch is also provided. The arc extinguishing chamber structure of the present invention has strong versatility, good practicality, a simple overall structure, and is easy to promote and apply.

### TECHNICAL FIELD

The present invention belongs to the technical field of low-voltage electrical equipment, and specifically relates to an arc extinguishing chamber structure of a circuit breaker or a disconnecting switch.

### BACKGROUND

Circuit breakers and disconnecting switches are the most important electrical equipment in power distribution systems and new energy systems. With the continuous improvement of system voltage, performance requirements for circuit breakers used for circuit protection are also increasing. Miniaturization, high performance, modularization, and high reliability are the main development directions of air circuit breakers and disconnecting switches at the current stage.

With the development of electric power, the applied voltage of power systems continues to increase, with AC voltage reaching AC 1500V and DC voltage increasing to DC 2500V. At the same time, because a DC system has no natural zero-crossing phenomenon of current compared to an AC system, it cannot extinguish an arc by utilizing the moment of AC current zero-crossing like AC does. It can only rely on rapidly elongating and cooling the arc to make the arc voltage exceed the power supply voltage, and then extinguish the arc. Therefore, arc extinguishing is relatively difficult. However, the requirement for miniaturization and high performance of circuit breakers inevitably requires that the space occupied by the arc extinguishing chamber structure becomes smaller and smaller, and the arc extinguishing capability needs to be higher and higher. Existing arc extinguishing chambers are difficult to meet this requirement.

### SUMMARY

The present invention provides an arc extinguishing chamber structure of a circuit breaker or a disconnecting switch, which solves the technical problem that current arc extinguishing chambers do not meet the low-volume and high-performance manufacturing requirements of power systems by means of an overall plug-in assembly, as well as the thickness variation design and the arrangement trend of internal grid plates.

The present invention can be realized through the following technical solutions:

An arc extinguishing chamber structure of a circuit breaker or a disconnecting switch, the whole adopting a plug-in structure assembly, a number of internal grid plates being arranged in an undulating manner, a variable curved surface formed by bottom surfaces thereof being designed to match an arc elongation process, and a thickness of each grid plate gradually becoming thinner from thick along an arc elongation direction.

Further, an end of a moving contact in the circuit breaker is provided with an arc-striking inclined surface, and the variable curved surface formed by the bottom surfaces of the grid plates is set as rising-horizontal-rising-horizontal.

Further, the variable curved surface formed by the bottom surfaces of the grid plates is denoted as a first rising segment, a first horizontal segment, a second rising segment, and a second horizontal segment, a holding point of the second horizontal segment cooperates with a moving arc-runner located at a side of the moving contact, a lowest point of the first rising segment cooperates with a stationary arc-runner located at a side of a stationary contact, and a highest point of the first rising segment is consistent with a highest point of a movement trajectory of the arc-striking inclined surface of the moving contact during an opening process.

Further, the thickness change of each grid plate along the arc elongation direction is set with two gradients or a multiple number of gradients.

Further, the grid plates are arranged in a row at intervals to form a grid plate group, a left side and a right side of the grid plate group are respectively assembled with respective corresponding side plates in a plug-in manner, a top of the grid plate group and tops of the two side plates are jointly inserted into an interior of a notch at a bottom of a cover, a bottom thereof is inserted into an interior of a gas-producing member, and the top and the bottom of each side plate are respectively connected with the cover and the gas-producing member through corresponding threads.

Further, two sides of tops of a number of grid plates located in a middle of the grid plate group are both provided with L-shaped notches, which form rectangular notches with the side plate at a corresponding side, an insert cooperating therewith is provided in the interior of each of the rectangular notches, and fixation of the three is completed through a bolt passing through a side wall of the cover, the side plate, and a screw hole on the corresponding insert for cooperation.

Further, a side of each insert in contact with the side plate is provided with a lug, and a position of each side plate corresponding to the lug is provided with a U-shaped groove cooperating therewith to define front and rear positions of the insert.

Further, a left side and a right side of each of the grid plates are both provided with a number of square protrusions extending outward, and a corresponding position of each of the side plates is provided with a slot hole cooperating with the square protrusions,

each of the grid plates is provided with two extending legs at a bottom thereof, the extending legs located at a same position are jointly inserted into the interior of a same gas-producing member, a cross section of the gas-producing member is a U-shaped structure, a width of an internal cavity matches a width of the extending legs, and an insertion slot cooperating with each of the extending legs is provided in the internal cavity,

one side surface of the gas-producing member is a gas-producing surface, another side surface is a mounting surface, and the mounting surface is inserted between the side plate and the grid plates and is connected with the side plate through a thread.

An assembly method of an arc extinguishing chamber structure of a circuit breaker or a disconnecting switch based on the above, comprising: sequentially inserting square protrusions on one side of each of the grid plates into corresponding slot holes of one of the side plates, then inserting slot holes of another side plate onto the square protrusions on the other side of each of the grid plates to realize plug-in assembly of the grid plates and the two side plates, then assembling two inserts into the interiors of corresponding rectangular notches from top to bottom, then snapping the cover onto top ends of the grid plates and the side plates, fixing the cover, the side plates, and the inserts together by using bolts, and finally inserting two gas-producing members onto corresponding extending legs of each of the grid plates from bottom to top, and fixing the gas-producing members and the side plates together by using bolts to complete assembly of the whole arc extinguishing chamber.

Beneficial technical effects of the present invention are as follows:

1. The arc extinguishing chamber structure of the present invention adopts an overall plug-in assembly to minimize external mounting space of various components and provide as much space as possible for internal grid plate mounting to prepare for enhancing arc extinguishing capability. At the same time, grid plates with large thickness are concentrated near an arc generation point, and grid plates with small thickness are concentrated in an area where arc extinguishing is nearly finished to maximize heat absorption acceleration and cool the arc. Furthermore, the arrangement trend of the grid plates matches the change trend of arc elongation to accelerate arc suction speed, reduce arc leakage, and improve arc extinguishing capability, thereby meeting existing power system manufacturing requirements for low-volume and high-performance arc extinguishing chambers.

2. Considering the relative positional relationship between the moving contact, the moving arc-runner, the stationary arc-runner, and the arc extinguishing chamber, the variable curved surface during arc elongation presents a rising-falling-rising-falling trend. Arranging each of the grid plates based on this makes the variable curved surface formed by their bottom surfaces consistent with the above trend, corresponding to the whole arc elongation process, and the gap between the two is controlled, thereby ensuring as much as possible that the arc can be quickly and completely sucked into the arc extinguishing chamber to accelerate arc extinguishing.

3. Relying on the added inserts to function as nuts for fixation, the cover and the side plates can be stably fixed together so that the two side plates can firmly clamp the grid plates therein without riveting. This can effectively avoid the risk of grid plate tilt and instability caused by weakening of riveting strength due to high temperatures during the arc extinguishing process, improving reliability of the arc extinguishing chamber. At the same time, the gas-producing member is assembled onto the extending legs by a plug-in method and then fixed with bolts, which improves the assembly convenience of the gas-producing member. Components of the entire arc extinguishing chamber are mainly based on plug-in and supplemented by thread fixation. By cleverly combining the two, the shell space occupancy of the arc extinguishing chamber can be effectively reduced, leaving as much internal space as possible for grid plate assembly, while also improving assembly and maintenance efficiency and reducing production and maintenance costs.

4. The arc extinguishing chamber structure of the present invention has strong versatility, good practicality, a simple overall structure, and is easy to promote and apply.

### BRIEF DESCRIPTION OF DRAWINGS

FIG. 1 is a schematic view of an overall structure of the present invention;

FIG. 2 is a schematic view of a variable curved surface of bottom surfaces of grid plates of the present invention;

FIG. 3 is a schematic view of a structure in which an insert and a rectangular notch cooperate in the present invention;

FIG. 4 is a schematic cross-sectional view of the overall structure of the present invention;

FIG. 5 is a schematic view of a structure of a gas-producing member of the present invention;

In which, 1-grid plate, 2-side plate, 21-U-shaped groove, 3-cover, 4-insert, 41-lug, 5-gas-producing member, 51-gas-producing surface, 52-mounting surface.

### DETAILED DESCRIPTION OF THE EMBODIMENTS

The specific embodiments of the present invention will be described in detail below in conjunction with the accompanying drawings and preferred embodiments.

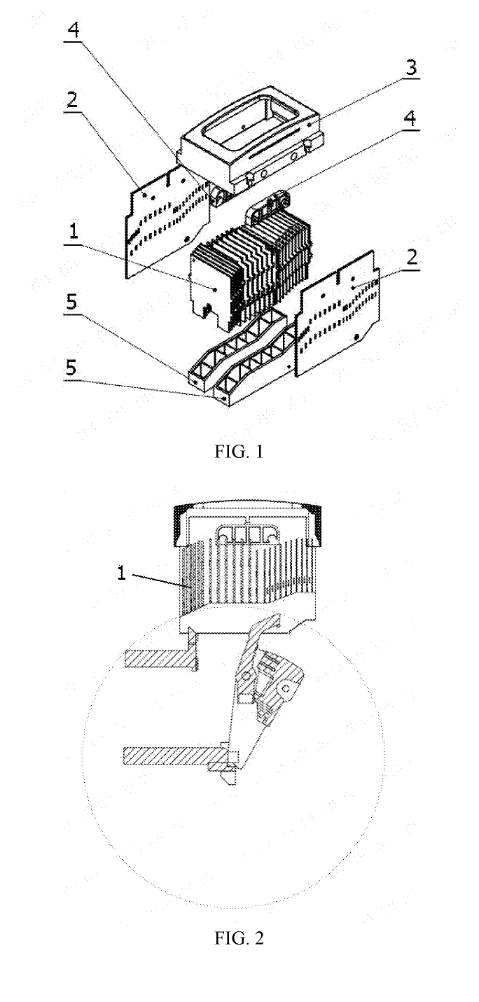

As shown in FIG. 1, the present invention proposes an arc extinguishing chamber structure of a circuit breaker or a disconnecting switch. The whole adopts a plug-in structure assembly, a number of internal grid plates 1 are arranged in an undulating manner, a variable curved surface formed by bottom surfaces thereof is designed to match an arc elongation process, and a thickness of each grid plate 1 gradually becomes thinner from thick along an arc elongation direction. In this way, the overall plug-in structure assembly is adopted to minimize external mounting space of various components and provide as much space as possible for internal grid plate mounting to prepare for enhancing arc extinguishing capability. At the same time, grid plates with large thickness are concentrated near an arc generation point to maximize heat absorption acceleration and cool the arc. Furthermore, the arrangement trend of the grid plates matches the change trend of arc elongation to accelerate arc suction speed, reduce arc leakage, and improve arc extinguishing capability, thereby meeting existing power system manufacturing requirements for low-volume and high-performance arc extinguishing chambers.

Details are as follows:

Generally, arc extinguishing chambers of DC circuit breakers mostly adopt a magnetic blow-out method for arc extinguishing. A moving contact thereof is composed of a combination of a number of short contact pieces and long contact pieces. At the same time, an end of each long contact piece is provided with an arc-striking inclined surface so that the arc can be quickly transferred to the arc-striking inclined surface, causing the arc to be elongated obliquely upward. Meanwhile, a stationary arc-runner and a moving arc-runner are correspondingly provided in the arc extinguishing chamber near a stationary contact side and a moving contact side, respectively, so as to introduce the arc into the arc extinguishing chamber for arc extinguishing. Thus, during an opening process of the moving and stationary contacts, the arc is elongated obliquely upward from a contact point between the stationary and moving contacts onto the arc-striking inclined surface of the moving contact, which is a first rising segment. Driven by an operating mechanism, the moving contact rotates to move away from the stationary contact. At this time, the arc crosses a highest point and starts to fall until opening is completed, which is a first falling segment. Then the arc transitions to the moving arc-runner having a slope consistent with that of the arc-striking inclined surface, which is a second rising segment. Finally, the arc is guided back to the arc extinguishing chamber in a reverse direction via the moving arc-runner, resulting in a reverse rising trend, which is a second falling segment. Therefore, the variable curved surface during the arc elongation process is denoted as A, which is mostly rising-falling-rising-falling. The variable curved surface formed by the bottom surfaces of the grid plates 1 at corresponding positions is denoted as B, which can also be set as rising-falling-rising-falling to make the trends of the variable curved surfaces A and B basically consistent. Moreover, a head end of the first rising segment is connected with the stationary arc-runner, a tail end of the second falling segment is connected with the moving arc-runner, and a gap between the two is defined, thereby ensuring that the arc can be quickly sucked into the arc extinguishing chamber, and cooperating with the moving arc-runner and the stationary arc-runner to introduce both a starting end and a terminating end of the arc into the arc extinguishing chamber, reducing arc leakage.

As shown in FIG. 2, while ensuring that the gap between the variable curved surfaces A and B is relatively stable, considering that the end of the moving contact mostly moves along a circular trajectory, at the start of opening, i.e., when the moving and stationary contacts are at a刚分点 (instant of separation) position, the end of the moving contact may not be at the highest point of its circular trajectory, but the arc will still transition to the end of the moving contact first and then move along the circular trajectory. Therefore, the highest point of the first rising segment can extend to the highest point of the circular trajectory. At the same time, the opening stroke is relatively small, and the circular movement trajectory of the end of the moving contact can be approximated as a straight line, i.e., the first falling segment can be replaced by a first horizontal segment. Furthermore, in order to transition the arc from the arc-striking inclined surface of the moving contact to the moving arc-runner, the slopes of the two need to be designed to be consistent. Therefore, the second falling segment can also be replaced by a second horizontal segment. In this way, arc extinguishing capability can be guaranteed and the complexity of grid plate arrangement can be simplified, further reducing manufacturing costs, while the trend of the variable curved surface B more closely follows the trend of the variable curved surface A.

In order to further improve arc extinguishing capability, the thickness of each of the grid plates 1 gradually becomes thinner from thick along the arc elongation direction. At an arc extinguishing start end, energy contained in the arc is very large. With the help of thick grid plates 1, this energy can be absorbed as quickly as possible and converted into heat energy. As the arc is elongated, the energy it contains gradually weakens. Therefore, closer to an arc extinguishing end, the thickness of the grid plates 1 can gradually decrease. Such a setting, compared to a conventional equal-thickness setting, better matches the energy change trend of the arc, and is more conducive to concentrating advantages to absorb energy in an initial stage of the arc to accelerate arc extinguishing.

Considering practical feasibility of manufacturing, the thickness change of the grid plates 1 may be set with a multiple number of gradients, preferably two gradients or three gradients.

In order to provide more space for mounting the grid plates 1, it is necessary to minimize space occupancy of a shell in the arc extinguishing chamber. Therefore, we design a plug-in structure to realize assembly of various components. First, each of the grid plates 1 is inserted between two side plates 2 at uniform intervals through a plug-in method. A left side and a right side of each grid plate 1 can be both provided with a number of square protrusions extending outward, such as two. A corresponding position of each side plate 2 is provided with a slot hole cooperating with the square protrusions, and the plug-in is realized through cooperation between the square protrusions and the slot holes.

Then, the cover 3 is assembled. Considering that a total mass of a grid plate group formed by arranging a number of grid plates 1 is relatively large, while a thickness of the side plates 2 is small and not suitable as threaded holes for locking, we added inserts 4 between the side plates 2 and the grid plate group. As shown in FIG. 3, two sides of tops of a number of grid plates located in the middle of the grid plate group can be designed with L-shaped notches, which can form rectangular notches with the side plate 2 at a corresponding side. Internal cavities of these two rectangular notches cooperate with the inserts 4. Then, with the help of bolts passing through a side wall of the cover, the side plate, and a screw hole on the corresponding insert 4 for cooperation, fixation of the three can be completed. Considering assembly convenience, only a width of each rectangular notch may cooperate with a width of the insert 4 to define a left-right position of the insert 4. At the same time, a side of each insert 4 in contact with the side plate 2 is provided with a lug 41, and a position of each side plate 2 corresponding to the lug 41 is provided with a U-shaped groove 21 cooperating therewith. In this way, by placing the lug into the U-shaped groove 21 and pressing the insert 4 from top to bottom, the insert 4 can be assembled into the interior of the rectangular notch. The cooperation between the lug 41 and the U-shaped groove 21 can define front and rear positions of the insert 4. Thus, through multi-directional fixation, the cover 3 and the side plates 2 can be stably fixed together, thereby enabling complete fixation of the number of grid plates 1 without riveting. This can effectively avoid the risk of grid plate tilt and instability caused by weakening of riveting strength due to high temperatures during the arc extinguishing process, improving reliability of the arc extinguishing chamber. Additionally, the insert 4 can adopt an integrated structure with the cover 3, or be pre-assembled into the interior of the cover 3 to enhance the degree of cooperation and tightness between the cover 3, the side plates 2, and the grid plate group.

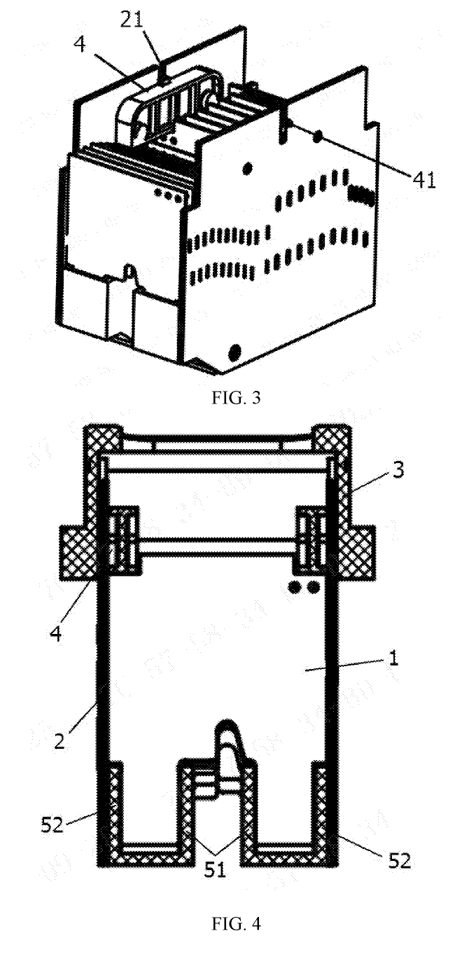

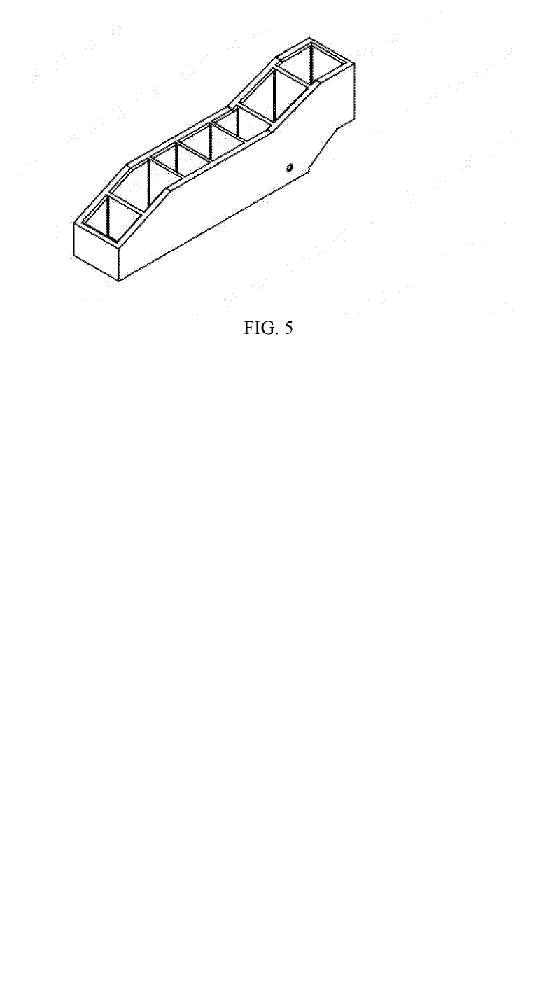

In order to facilitate assembly of gas-producing members 5, as shown in FIG. 1, FIG. 4, and FIG. 5, a cross section of each gas-producing member 5 is a U-shaped structure, a width of an internal cavity matches a width of extending legs, and an insertion slot cooperating with the extending legs of each grid plate 1 is provided in the internal cavity. One side surface of the gas-producing member 5 is a gas-producing surface 51, and another side surface is a mounting surface 52. The gas-producing member 5 is inserted onto extending legs on a corresponding side from bottom to top, so that the extending legs on the same side are jointly assembled into the insertion slots inside the same gas-producing member 5. The mounting surface 52 is inserted between the side plate 2 and the grid plates 1, and can be connected with the side plate 2 through a bolt.

The present invention further provides an assembly method of an arc extinguishing chamber structure of a circuit breaker or a disconnecting switch based on the above. First, square protrusions on one side of each of the grid plates are sequentially inserted into corresponding slot holes of one of the side plates, then slot holes of another side plate are inserted onto the square protrusions on the other side of each of the grid plates to realize plug-in assembly of the grid plates and the two side plates. Then, lugs of two inserts are aligned with the U-shaped grooves, and the inserts are pressed from top to bottom to assemble them into the interiors of corresponding rectangular notches. Then, the cover is snapped onto top ends of the grid plates and the side plates to define front-rear, left-right, and up-down positions of the grid plates and the side plates, and the cover, the side plates, and the inserts are fixed together by using bolts to realize assembly stability.

Finally, two gas-producing members are inserted onto corresponding extending legs of each of the grid plates from bottom to top, and the gas-producing members and the side plates are fixed together by using bolts to complete assembly of the whole arc extinguishing chamber. When a gas-producing member is damaged, it can be pulled out and replaced simply by removing the bolts.

Although specific embodiments of the present invention have been described above, those skilled in the art should understand that these are only examples. Various changes or modifications can be made to these embodiments without departing from the principles and essence of the present invention. Therefore, the scope of protection of the present invention is defined by the appended claims.

What is claimed is:

1. An arc extinguishing chamber structure of a circuit breaker or a disconnecting switch, characterized in that: the whole adopts a plug-in structure assembly, a number of internal grid plates are arranged in an undulating manner, a variable curved surface formed by bottom surfaces thereof is designed to match an arc elongation process, and a thickness of each grid plate gradually becomes thinner from thick along an arc elongation direction.

2. The arc extinguishing chamber structure of the circuit breaker or the disconnecting switch according to claim 1, characterized in that: an end of a moving contact in the circuit breaker is provided with an arc-striking inclined surface, and the variable curved surface formed by the bottom surfaces of the grid plates is set as rising-horizontal-rising-horizontal.

3. The arc extinguishing chamber structure of the circuit breaker or the disconnecting switch according to claim 2, characterized in that: the variable curved surface formed by the bottom surfaces of the grid plates is denoted as a first rising segment, a first horizontal segment, a second rising segment, and a second horizontal segment, a holding point of the second horizontal segment cooperates with a moving arc-runner located at a side of the moving contact, a lowest point of the first rising segment cooperates with a stationary arc-runner located at a side of a stationary contact, and a highest point of the first rising segment is consistent with a highest point of a movement trajectory of the arc-striking inclined surface of the moving contact during an opening process.

4. The arc extinguishing chamber structure of the circuit breaker or the disconnecting switch according to claim 1, characterized in that: the thickness change of each grid plate along the arc elongation direction is set with two gradients or a multiple number of gradients.

5. The arc extinguishing chamber structure of the circuit breaker or the disconnecting switch according to claim 1, characterized in that: the grid plates are arranged in a row at intervals to form a grid plate group, a left side and a right side of the grid plate group are respectively assembled with respective corresponding side plates in a plug-in manner, a top of the grid plate group and tops of the two side plates are jointly inserted into an interior of a notch at a bottom of a cover, a bottom thereof is inserted into an interior of a gas-producing member, and the top and the bottom of each side plate are respectively connected with the cover and the gas-producing member through corresponding threads.

6. The arc extinguishing chamber structure of the circuit breaker or the disconnecting switch according to claim 5, characterized in that: two sides of tops of a number of grid plates located in a middle of the grid plate group are both provided with L-shaped notches, which form rectangular notches with the side plate at a corresponding side, an insert cooperating therewith is provided in the interior of each of the rectangular notches, and fixation of the three is completed through a bolt passing through a side wall of the cover, the side plate, and a screw hole on the corresponding insert for cooperation.

7. The arc extinguishing chamber structure of the circuit breaker or the disconnecting switch according to claim 6, characterized in that: a side of each insert in contact with the side plate is provided with a lug, and a position of each side plate corresponding to the lug is provided with a U-shaped groove cooperating therewith to define front and rear positions of the insert.

8. The arc extinguishing chamber structure of the circuit breaker or the disconnecting switch according to claim 5, characterized in that: a left side and a right side of each of the grid plates are both provided with a number of square protrusions extending outward, and a corresponding position of each of the side plates is provided with a slot hole cooperating with the square protrusions,
each of the grid plates is provided with two extending legs at a bottom thereof, the extending legs located at a same position are jointly inserted into the interior of a same gas-producing member, a cross section of the gas-producing member is a U-shaped structure, a width of an internal cavity matches a width of the extending legs, and an insertion slot cooperating with each of the extending legs is provided in the internal cavity,
one side surface of the gas-producing member is a gas-producing surface, another side surface is a mounting surface, and the mounting surface is inserted between the side plate and the grid plates and is connected with the side plate through a thread.

9. An assembly method of an arc extinguishing chamber structure of a circuit breaker or a disconnecting switch according to claim 1, characterized in that: square protrusions on one side of each of the grid plates are sequentially inserted into corresponding slot holes of one of the side plates, then slot holes of another side plate are inserted onto the square protrusions on the other side of each of the grid plates to realize plug-in assembly of the grid plates and the two side plates, then two inserts are assembled into the interiors of corresponding rectangular notches from top to bottom, then the cover is snapped onto top ends of the grid plates and the side plates, the cover, the side plates, and the inserts are fixed together by using bolts, and finally two gas-producing members are inserted onto corresponding extending legs of each of the grid plates from bottom to top, and the gas-producing members and the side plates are fixed together by using bolts to complete assembly of the whole arc extinguishing chamber.

10. The assembly method of claim 9, characterized in that: an end of a moving contact in the circuit breaker is provided with an arc-striking inclined surface, and the variable curved surface formed by the bottom surfaces of the grid plates is set as rising-horizontal-rising-horizontal.

11. The assembly method of claim 10, characterized in that: the variable curved surface formed by the bottom surfaces of the grid plates is denoted as a first rising segment, a first horizontal segment, a second rising segment, and a second horizontal segment, a holding point of the second horizontal segment cooperates with a moving arc-runner located at a side of the moving contact, a lowest point of the first rising segment cooperates with a stationary arc-runner located at a side of a stationary contact, and a highest point of the first rising segment is consistent with a highest point of a movement trajectory of the arc-striking inclined surface of the moving contact during an opening process.

12. The assembly method of claim 9, characterized in that: the thickness change of each grid plate along the arc elongation direction is set with two gradients or a multiple number of gradients.

13. The assembly method of claim 9, characterized in that: the grid plates are arranged in a row at intervals to form a grid plate group, a left side and a right side of the grid plate group are respectively assembled with respective corresponding side plates in a plug-in manner, a top of the grid plate group and tops of the two side plates are jointly inserted into an interior of a notch at a bottom of a cover, a bottom thereof is inserted into an interior of a gas-producing member, and the top and the bottom of each side plate are respectively connected with the cover and the gas-producing member through corresponding threads.

14. The assembly method of claim 13, characterized in that: two sides of tops of a number of grid plates located in a middle of the grid plate group are both provided with L-shaped notches, which form rectangular notches with the side plate at a corresponding side, an insert cooperating therewith is provided in the interior of each of the rectangular notches, and fixation of the three is completed through a bolt passing through a side wall of the cover, the side plate, and a screw hole on the corresponding insert for cooperation.

15. The assembly method of claim 14, characterized in that: a side of each insert in contact with the side plate is provided with a lug, and a position of each side plate corresponding to the lug is provided with a U-shaped groove cooperating therewith to define front and rear positions of the insert.

16. The assembly method of claim 13, characterized in that: a left side and a right side of each of the grid plates are both provided with a number of square protrusions extending outward, and a corresponding position of each of the side plates is provided with a slot hole cooperating with the square protrusions,
each of the grid plates is provided with two extending legs at a bottom thereof, the extending legs located at a same position are jointly inserted into the interior of a same gas-producing member, a cross section of the gas-producing member is a U-shaped structure, a width of an internal cavity matches a width of the extending legs, and an insertion slot cooperating with each of the extending legs is provided in the internal cavity,
one side surface of the gas-producing member is a gas-producing surface, another side surface is a mounting surface, and the mounting surface is inserted between the side plate and the grid plates and is connected with the side plate through a thread.
